(19) United States
(12) Patent Application Publication
(10) Pub. No.: US 2025/0011253 A1
(43) Pub. Date: Jan. 9, 2025

(54) A GRANULAR BIOSTIMULANT AS PLANT GROWTH PROMOTER, PROCESSES FOR PREPARING THE SAME AND USES THEREOF

(71) Applicants: UPM-KYMMENE CORPORATION, Helsinki (FI); GREEN INNOVATION GMBH, Innsbruck (AT)

(72) Inventors: Suvi Pietarinen, Helsinki (FI); Giuliano Leonardi, Innsbruck (AT); Christian Hubsch, Helsinki (FI)

(21) Appl. No.: 18/710,243

(22) PCT Filed: Nov. 7, 2022
(86) PCT No.: PCT/EP2022/081007

§ 371 Date: May 15, 2024

(30) Foreign Application Priority Data
Nov. 15, 2021 (IT) 102021000028904

(51) Int. Cl. C05F 11/08; C05G 5/12

(52) U.S. Cl. CPC C05F 11/08; C05G 5/12

(57) ABSTRACT

A biostimulant is disclosed including a solid mixture of a) granules including a fungus of Trichoderma genus and at least one binding agent, and b) granules including a lignin fraction and optionally at least one carrier, as well as processes for preparing the same and uses as a plant growth and fruit production promoter in agriculture. In an additional aspect, an agro-chemical product is also disclosed including the biostimulant and agro-chemical additives.

### FIELD OF THE INVENTION

The present invention concerns a granular biostimulant comprising a fungus of Trichoderma genus and a lignin fraction, as well as processes for preparing the same and uses as a plant growth and fruit production promoter in agriculture.

### State of the Art

Fertilizer, which essentially consisting of various types of nutritive components for plant growth, has been widely employed throughout the world to improve the yields of agriculture products. Generally, fertilizers may be in the forms of pure liquid, suspensions or solid. They can be introduced to plants through soil feeding or by applying to the foliage of the plants such as spraying, irrigation, and the likes.

Many fertilizers are known to be marketed in a powdered form, to be solubilized in water upon use. However, the difficult workability of powders and their inherent risk of dispersion into the environment, along with the inherent risk for the operators, have made said powders less appealing and appreciable, although powders are in principle more convenient from the point of view of storage and transportation.

In these recent years, foliar fertilizer has gradually replaced the common usage of soil-applied fertilizer in agricultural sites as they have fewer negative impacts to the environmental. Studies showed that conventional fertilization method through soil feeding has contributed to water surface and groundwater contamination. This is mainly due to the leaching of the soluble nutrients of the fertilizer, such as nitrogen, into the aquifer. Such circumstances may result to poor transportation of nutrients to the plant cells. Therefore, it was found to be more desirable to supply nutrients directly to a plant through the foliage of plants. Foliar fertilizers seem to overcome the disadvantages of soil feeding method, however, improper application of such foliar fertilizers to plants, for example, when a high concentration of nutrients is being directly applied on the foliage, can lead to foliage damage in the form of necrotic areas or burning of the leaves, and hence causes reduction in crop yields. It is assumed that foliar fertilizer with reduced amount of nutrients can prevent the foliage damage. However, it is impractical as a labor-intensive operation is required to fertilize the plants with the low nutrients content foliar fertilizer. As an example, U.S. Pat. No. 6,475,258 disclosed a foliar fertilizer composition for enhancing the growth of plants through foliar application. Said composition is an aqueous solution consisting of at least one coenzyme, wherein said coenzyme is preferably a vitamin B, and more preferably folic acid and/or pyridoxine, and at least one of a carbohydrate source, a complexing agent and a preservative. Although the subject fertilizer can substantially improve the nutrients uptake by plants, through enhancing their metabolism activities, however, the availability of nutrients either from soils or from foliar fertilizers to be incorporated into the plants cell has yet to be addressed.

Another inconvenient is the fact that, although water solutions and suspensions are preferable and particularly suitable for applying fertilizers to crops, at the same time the storage and transportation overall costs and long-term instability can negatively affect their commercial exploitation.

A class of plant products is known having the properties of being complementary to crop nutrition and crop protection, this class being plant biostimulants. A plant biostimulant is any substance or microorganism applied to plants with the aim to enhance nutrition efficiency, abiotic stress tolerance and/or crop quality traits, regardless of its nutrients content.

According to the European Biostimulants Industry Council (EBIC), biostimulants distinguish themselves from traditional crop inputs in two main ways:
biostimulants operate through different mechanisms than fertilizers, regardless of the presence of nutrients in the products, and
they act only on the plant's vigour.

As said, the nature of the biostimulant is not restrictive: it can be a substance or a microorganism. Instead, the agricultural functions form the core of the definition.

Biostimulants are defined by intended agricultural outputs. ‘Nutrition efficiency’ may cover nutrient mobilization and uptake from the soil, root development, transport, storage and assimilation (i.e. conversion of inorganic to organic forms) of nutrients in the plant. ‘Abiotic stress’ refers to any physical or chemical stressor of non biological origin (drought, salinity, cold, etc.). ‘Quality traits’ may be diverse and range from nutritional value to shelf life or flower pigmentation. Any of these effects should be distinct from those resulting from the nutrient content of the biostimulant. Biostimulants are not fertilisers in the sense they do not contain nutrients intended to be delivered to the plant.

However, they may facilitate nutrient acquisition, e.g. by mobilizing elements in the rhizosphere or by developing new routes of nutrient acquisition, like fixation of atmospheric N by the recruitment of bacterial endosymbionts.

Technical challenges for the development of biostimulants include the formulation and blending of biostimulants with other fertilising materials and/or plant protection products.

Many biostimulants aim at improving nutrient use efficiency and combinations between fertilisers and biostimulants will need to be optimized. Formulation of biofertilisers is specially complex, and positive interactions between microbiological components of the biostimulants mixtures on one hand, and between the biostimulant inoculant and the resident rhizo-/endospheric microbiota on the other hand, have to be searched for.

It is therefore felt the need of a product effectively stimulating the plant growth, without causing any damage on foliage, at the same time showing a long-term storage stability, and formulability with fertilizers and pesticides, as well as involving more sustainable overall costs.

### SUMMARY OF THE INVENTION

The above object has been achieved by a biostimulant comprising a solid mixture of
a) granules comprising a fungus of Trichoderma genus and
b) granules comprising a lignin fraction, as claimed in claim 1.

For the purposes of the present invention, with the terms “granule”, “granules”, “granulated” or “granular”, it is meant a solid small particle having regular or irregular shape, such as sphere, spheroid, pellet, flake, or tablet, and an average particle size distribution D₅₀ of 0.2-4.0 mm.

In another aspect, the present invention relates to a use of said biostimulant as a plant growth and fruit production promoter in agriculture.

In an additional aspect, the present invention concerns an agro-chemical product comprising the biostimulant and agro-chemical additives.

In a further aspect, the present invention concerns a method for promoting plant growth and fruit production, said method comprising the step of applying the biostimulant or the agro-chemical product to a plant or plant soil.

The term “plant” denotes a plant or plants that can be grown and harvested for profit or subsistence, thus including plants of crops, cereals, vegetables, fruits, flowers, as well as seeds, tubers, and bulbs, as well as grown and harvested for gardening or personal use.

The expression “to a plant” means that the biostimulant or the agro-chemical product can be applied to any part of the plant, including root, trunk, branch, twig, leaf, flower, and fruit.

The term “plant soil” denotes the soil where the plant is growing or where the plant is sowed or where the plant will be sowed, thus including grounds, lands, and soilless media, such as in hydroculture and hydroponics.

The characteristics and the advantages of the present invention will become clear from the following detailed description, and the working examples provided for illustrative purposes.

### DETAILED DESCRIPTION OF THE INVENTION

The subject of the invention therefore is a biostimulant comprising a solid mixture of:
a) granules comprising a fungus of Trichoderma genus in a concentration of 1×10⁵ to 1×10¹⁰ spores/g of granules a), and at least one binding agent, and
b) granules comprising a lignin fraction in a concentration at least 50 wt %, on the weight of granules b),
   wherein:
said fungus is selected from Trichoderma species, their protoplast fusants, and mixtures thereof,
said lignin fraction comprises fragments having a weight average molecular weight up to 20,000 Da, as measured by Size-Exclusion Chromatography, said fragments comprising up to 111 phenylpropane units on weight average, and
said granules a) and said granules b) have, independently of each other, an average particle size distribution D₅₀ of 0.2-4.0 mm.

The solid mixture of the invention has allowed to surprisingly achieve a number of technical results and advantages, at the same time overcoming some drawbacks of the known granular products.

Granules are certainly the most widespread physical form for fertilizers and for all those agricultural products which, although falling within the broader category of fertilizers, constitute products with a specific action, such as micronutrients, soil enhancers, inoculants of fungi and mycorrhizae, pH correctors, and so on. Actually, granular formulations encompass some advantages, such as:
absence of dustiness,
easy sliding in mechanical devices (without undesired packing effects),
easiness to store,
possibility of slow-release formulations,
uniform nutrient distribution,
no segregation of the nutrients during the handling or spreading of the product,
higher efficiency for preplant application.

As said, granules a) and granules b) have, independently of each other, an average particle size distribution D₅₀ of 0.2-4.0 mm. For the purposes of the present invention, this parameter is measured by sieve analysis in accordance with EN 1235 [i.e. EN 1235: Solid fertilizers—Test sieving (ISO 8397:1988, modified) (including Amendment A1:2003)].

The average grain size and the particle size distribution are important quality characteristics for solid fertilizers and related products. Sieve analysis has been declared the obligatory process for the determination of particle size distribution for solid fertilizer products sold in the European Union and all associated instruments and procedures are governed by EN 1235. In accordance with EN 1235, solid fertilizers are to be subjected to a screening analysis employing 200-millimeter diameters laboratory test sieves manufactured according to the requirements of ISO 3310-1. The standard calls for a maximum of seven test sieves to be used for the gradation test, covering the complete size distribution spectrum of the sample material. The selection of aperture sizes should be made from the R20/3 series of ISO 565, although the use of additional sieves from the R20 series is explicitly permitted in the standard. The requirements of EN 1235 were determined in a series of ring trials using Woven Wire Cloth Sieves with aperture width from 100 μm to 5.60 mm.

Granular products are solid homogeneous mixtures generally produced in granulation plants by combining various raw materials. Each uniformly sized particle contains all the components in the analysis.

Different granulation processes are known, such as:
dry granulation,
wet granulation,
by spray dryer,
fluidized bed spray,
pan granulator.

In all the various processes, the parameters involved are such as to generate a more or less intense stress (thermal, mechanical, rheological) on the ingredients making the granules.

In addition to the process parameters (such as mixing times and intensity, quantity of water/solvent, temperature and drying times and methods), it is possible or necessary to introduce agglomerating agents or binders to give the granule the right consistency to maintain the structure during the handling, storage and application phases, but also the right ability (and speed) to dissolve in the ground or in the dispersing water. In addition, it should be also considered that during the granulation process, there is a strong and intense interaction between the different ingredients which must be evaluated in advance, in order to avoid undesired chemical reactions, i.e. denaturation, of living microbiological components (even if quiescent).

Therefore, although in principle, granular formulations are advantageous, anyway the granulation operative conditions could negatively affect the ingredients present therein and reduce the overall efficacy and stability overtime of the resulting granular product, especially when a microorganism such a fungus is involved as ingredient.

In the present case, the challenge has been not only to consider a fungus in a granular biostimulant, but also to combine the same with a lignin fraction.

Lignin is known to have an antimicrobial activity against both fungi and bacteria. The lignin fraction, as below described in more details, shows an even higher and intense antimicrobial activity, as its fragments, resulting from depolymerization processes, are more active and reactive.

Notwithstanding this, surprisingly and unexpectedly, Trichoderma species were not only unaffected by the lignin fraction, when in liquid formulations, but even increased their activity in terms of plant productivity as well as in terms of plant growth.

In addition to what above, it should be appreciated that Trichoderma species and lignin fraction work in different manners and use different mechanisms: this makes the resulting composition effect to be more robust and suitable in a variety of conditions, while reducing the insurgence of resistance mechanisms (for biocontrol).

However, when the same formulations are granulated, anyway the above-mentioned stressful conditions gave some problems in the fungus vitality and activity overtime, especially after long-time storage.

Therefore, the solid mixture of the present invention has surprisingly allowed to exploit the advantages of the association of Trichoderma species and lignin fraction, as well as the advantages of the granular formulations, without incurring in the known drawbacks of the granulation processes.

As a matter of fact, Trichoderma species and lignin fraction are separately granulated in different and distinct granulation processes obtaining granules a) and granules b) respectively, that are mixed with each other to give the solid mixture, and can be long-term stored and then re-dispersed or re-suspended in liquid formulations upon use, while keeping their activity and efficacy.

Preferably, said Trichoderma species is selected from Trichoderma aggressivum, Trichoderma asperellum, Trichoderma atroviride, Trichoderma citrinoviride, Trichoderma cremeum, Trichoderma harzianum, Trichoderma koningii, Trichoderma longibrachiatum, Trichoderma reesei, Trichoderma virens, Trichoderma viride, and Trichoderma viridescens.

A fungus belonging to Trichoderma genus as defined above are able to colonize a variety of niches, antagonize and control plant pathogenic microorganisms and establish a direct beneficial interaction with plants resulting in the enhancement of growth, nutrient uptake and systemic resistance to diseases. In particular, improvement in plant development is generally associated with increased seed germination, root system, plant weight and leaf area, size and/or number of seeds flowers and/or fruits with a consequent increase in yields and often in the content of important nutritional factors.

With the term “protoplast fusants” is meant to include hybrid strains of Trichoderma spp. obtained via protoplast fusion.

Protoplasts are the cells of which cell walls are removed and cytoplasmic membrane is the outermost layer in such cells. Protoplast can be obtained by specific lytic enzymes to remove cell wall. Protoplast fusion is a physical phenomenon, during fusion two or more protoplasts come in contact and adhere with one another either spontaneously or in presence of fusion inducing agents. By protoplast fusion, it is possible to transfer some useful genes from one species to another. Protoplast fusion is an important tool in strain improvement for bringing genetic recombinations and developing hybrid strains in filamentous fungi. Said improvement can involve for example higher yields in cellulase production.

Protoplast fusants for the purposes of the present invention can be obtained according to techniques known in the art (e.g. Hassan MM (2014) Influence of protoplast fusion between two Trichoderma spp. on extracellular enzymes production and antagonistic activity, Biotechnology & Biotechnological Equipment, 28:6, 1014-1023) In preferred embodiments of the biostimulant of the invention, the fungus of Trichoderma genus is selected from T. Harzianum, T. Atroviride and T. virens, and mixtures thereof.

In some embodiments, the biostimulant comprises a mixture of Trichoderma species.

In more preferred embodiments, said fungus is selected from T. Harzianum HK2, T. Atroviride HK4 and T. virens GV41, and mixtures thereof, wherein “HK2”, “HK4” and “GV41” are the respective preferred strains.

HK2 has an ATCC number of PTA-9708 and was disclosed U.S. Pat. No. 8,716,001.

HK4 has an ATCC number of PTA-9707 and was disclosed in U.S. Pat. No. 8,877,480.

GV41 is commercially available from BioWorks Inc. NY 14564, USA.

In some embodiments, the biostimulant comprises a mixture of Trichoderma strains.

When a mixture is present in the biostimulant, each species or strain is at the same or about the same concentration.

In preferred embodiments, the biostimulant comprises two different Trichoderma species or two Trichoderma strains in a concentration ratio of 2:1 to 1:2, preferably 1:1. Preferably, the fungus is in a concentration of 1×10⁵ to 1×10¹⁰ spores/g of granules a). Lignin is a class of complex organic polymers that form important structural materials in the support tissues of some algae, vascular plants, included their bark, and herbaceous plants, such as wood (i.e. softwood and hardwood), straw of all cereals, cane bagasse, grass, linen, jute, hemp, or cotton. Lignin can also have mineral source, such as peat, leonardite and coal.

Chemically, in its native form, lignin is a very irregular, randomly cross-linked polymer of phenylpropane units joined by many different linkages, with a weight average molecular weight of 20,000 Da or higher. A representative and illustrative lignin fragment (I) containing the most important bonding patterns is shown herein below:

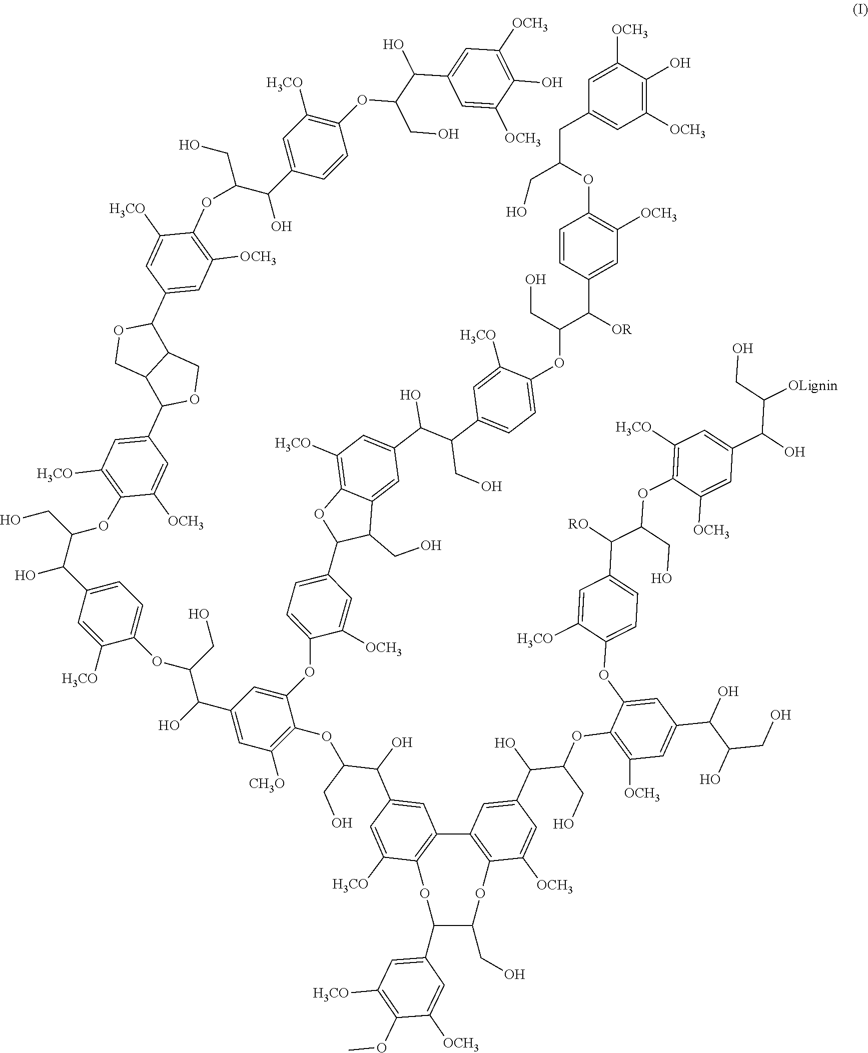

Said polymer is the result of an enzyme-mediated dehydrogenative polymerization of three phenylpropanoid monomer precursors:

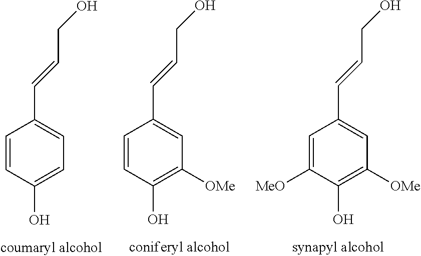 [SMILES: OC/C=C/c1ccc(O)cc1 ; COc1cc(/C=C/CO)ccc1O ; COc1cc(/C=C/CO)cc(OC)c1O]

which result in the following moieties, respectively:

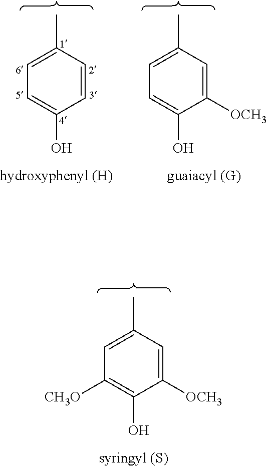

Coniferyl alcohol occurs in all species and is the dominant monomer in conifers (softwoods). Deciduous (hardwood) species contain up to 40% synapyl alcohol units while grasses and agricultural crops may also contain coumaryl alcohol units.

Lignin can be categorized to softwood and hardwood lignins according to their raw biomass sources.

Raw biomass sources that can be suitable starting materials for obtaining the relevant lignin fraction are any lignin including essentially pure lignin as well as kraft lignin, biomass originating lignin, lignin from alkaline pulping process, lignin from soda process, lignin from organosolv pulping, lignin from enzymatic processes, lignin from steam explosion processes, and any combination thereof.

By the expression “essentially pure lignin”, it should be understood as at least 80% pure lignin on a dry raw biomass basis, preferably at least 90% pure lignin, more preferably at least 95% pure lignin, the remainder being extractives and carbohydrates such as hemicelluloses as well as inorganic matter.

By the expression “kraft lignin”, it is to be understood lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different techniques including e.g. precipitation and filtration. Lignin usually begins precipitating at pH values below 11-12. Different pH values can be used in order to precipitate lignin fractions with different properties. These lignin fractions may differ from each other by molecular weight distribution, e.g. M_{w} and Mₙ, polydispersity, hemicellulose and extractive contents, contents of inorganic material. The precipitated lignin can be purified from inorganic impurities, hemicellulose and wood extractives using acidic washing steps. Further purification can be achieved by filtration.

Alternatively, the lignin is separated from pure biomass. The separation process can begin with liquidizing the biomass with strong alkali followed by a neutralization process. After the alkali treatment, the lignin can be precipitated in a similar manner as presented above.

Preferably, the separation of lignin from biomass comprises a step of enzyme treatment.

The enzyme treatment modifies the lignin to be extracted from biomass. Lignin separated from pure biomass is essentially sulphur-free (sulphur content less than 3%) and thus valuable in further processing. Preferably, wood material is pre-treated to remove hemicelluloses and thereafter cellulose has been hydrolysed. The resulting insoluble lignin fraction comprises up to 30 wt % of cellulose.

Preferably, the separated lignin is also subjected to a depolymerization process in order to further reduce the weight average molecular weight of fragments.

In some embodiments, the separated lignin is also subjected to a depolymerization process in order to further reduce the weight and number average molecular weights of fragments.

Suitable depolymerization processes include base-catalyzed depolymerization, acid-catalyzed depolymerization, metallic catalyzed depolymerization, ionic liquids-assisted depolymerization, and supercritical fluids-assisted lignin depolymerization.

In preferred embodiments, said lignin fraction is obtained by base-catalyzed depolymerization.

Preferably, said lignin fraction is obtained by subjecting the separated lignin to a base-catalyzed depolymerization at a temperature lower than 300° C. and a pressure lower than 30 MPa.

The pH is set between 11 and 14, by adding a base such as NaOH, KOH, Ca(OH)₂, LiOH, K₂CO₃, or a mixture thereof.

The weight average molecular weight (M_{w}) of fragments in the lignin fraction is measured by Size-Exclusion Chromatography (or ‘SEC’). SEC employs a stagnant liquid present in the pores of beads as the stationary phase, and a flowing liquid as the mobile phase.

The mobile phase can therefore flow between the beads and also in and out of the pores in the beads. The separation mechanism is based on the size of the polymer molecules in solution. Bigger molecules will elute first. Small molecules that can enter many pores in the beads take a long time to pass through the column and therefore exit the column slowly. To determine the molecular weights of the components of a polymer sample, a calibration with standard polymers of known weight must be performed. Values from the unknown sample are then compared with the calibration graph. The retention times depend on the used column material, eluent and how similar the used standards are compared to the samples. Preferably, the eluent is preferably 0.1 M NaOH.

Preferably, said lignin fraction comprises fragments having a weight average molecular weight of 2,000-20,000 Da.

More preferably, said lignin fraction comprises fragments having a weight average molecular weight of 3,000-20,000 Da.

Even more preferably, said lignin fraction comprises fragments having a weight average molecular weight of 4,000-15,000 Da.

In some preferred embodiments, said lignin fraction comprises fragments having a weight average molecular weight of 4,000-8,000 Da.

In other preferred embodiments, said lignin fraction comprises fragments having a weight average molecular weight of 9,000-11,000 Da.

Preferably in these embodiments, said fragments comprise 11-111 phenylpropane units on weight average, more preferably, 22-111 phenylpropane units on weight average.

The molecular weight of the three phenylpropanoid monomer precursors varies between 150 Da of coumaryl alcohol, 180 Da of coniferyl alcohol, and 210 Da of synapyl alcohol. The average weight is therefore 180 Da and this value has been used as “phenylpropane unit”. The M_{w} values have been divided by 180 Da, thus obtaining the phenylpropane unit numbers on weight average.

Preferably, the lignin fraction comprises fragments having a number average molecular weight (Mₙ) up to 2,000 Daltons.

For the purposes of the present invention, the number average molecular weight (Mₙ) of fragments in the lignin fraction is measured by Size-Exclusion Chromatography.

More preferably, the lignin fraction comprises fragments having a number average molecular weight (Mₙ) up to 1,500 Daltons.

In preferred embodiments, said lignin fraction comprises fragments having a number average molecular weight of 150 Daltons to 1,300 Daltons.

Without wishing to be bound by any theory, it is believed that lower number average molecular weights mean more active molecules. This is put forward considering that lower molecular weights mean smaller fragments, and smaller fragments mean less crosslinked/shorter fragments, and less crosslinked/shorter fragments mean a higher number of free functional groups thereon, thus more reactive fragments.

Moreover, it is believed that smaller molecules can easily pass through the cell membrane of pathogens and diffuse therewithin, thus significantly increasing the overall effectiveness of the lignin fraction.

Preferably in these embodiments, said fragments comprise up to 11 phenylpropane units on number average, more preferably, up to 8 phenylpropane units on number average.

The molecular weight of the three phenylpropanoid monomer precursors varies between 150 Da of coumaryl alcohol, 180 Da of coniferyl alcohol, and 210 Da of synapyl alcohol. The average weight is therefore 180 Da and this value has been used as “phenylpropane unit”. The Mₙ values have been divided by 180 Da, thus obtaining the phenyl propane unit numbers on number average.

In preferred embodiments, said lignin fraction comprises fragments having a weight average molecular weight (M_{w}) of 150 Daltons to 2,500 Daltons, and fragments having a number average molecular weight (Mₙ) up to 2,000 Daltons.

More preferably, said lignin fraction comprises fragments having a weight average molecular weight (M_{w}) of 150 Daltons to 2,500 Daltons and 2 to 13 phenylpropane units on weight average, and fragments having a number average molecular weight (Mₙ) up to 2,000 Daltons and up to 11 phenylpropane units on number average.

In further embodiments, the lignin fraction has a polydispersity index (PDI) of 1.25 to 12.

The polydispersity index (PDI) or heterogeneity index, or simply dispersity, is a measure of the distribution of molecular mass in a given polymer sample. PDI is the weight average molecular weight (M_{w}) divided by the number average molecular weight (Mₙ). It indicates the distribution of individual molecular masses in a batch of polymers.

Preferably, said lignin fraction further comprises up to 30 wt % of cellulose, more preferably 10-30 wt % of cellulose, based on the weight of the lignin fraction. The fungus of Trichoderma genus produces cellulose-degrading enzymes such as exoglucanase (EXG), endoglucanase (EG) and β-glucosidase (BGL). Cellulases are the most efficient enzyme system for the complete hydrolysis of cellulosic substrates into its monomeric glucose, which is a fermentable sugar. As sugar helps plant cellular respiration and cell growth, it follows that the presence of cellulose in the biostimulant of the invention is advantageous for further improving the overall efficiency in promoting the plant growth.

Preferably, in granules a), said at least one binding agent is selected from kaoline, starch, modified starch, starch phosphate, pectin, modified pectin, amylopectin, alginic acid, sodium alginate, guar gum, guar flour, tragacanth, gum arabic, xanthan gum, karaya gum, tara gum, tamarind gum, gellan gum, locust bean gum, gelatin, carob seed flour, galactomannan, glucomannan, dextran, carrageenan, mannan, arabinogalactan, pullulan, maltodextrin, cellulose, derivatized cellulose, carboxymethyl cellulose, sodium carboxymethyl cellulose, soy polysaccharide, chitosan, or a mixture thereof.

More preferably, said at least one binding agent is selected from starch, modified starch, starch phosphate, and mixtures thereof.

In preferred embodiments, granules a) further comprise wetting agents, disintegrating agents, dispersing agents, or mixtures thereof.

Wetting agents can reduce the surface tension of water, allowing the wetting agents to enter hydrophobic soil medium and thereby facilitate infiltration; they vary in their effect on water surface tension, water infiltration and water retention. A suitable wetting agent is selected from the group consisting of alkylsulfate salts, arylsulfonate salts, polyoxyalkylene alkyl ethers, alkenylsulfonate salts, polyoxyethylene styryl phenyl ethers, polyoxyethylene distyryl phenyl ethers, polyoxyethylene tristyryl phenyl ethers, polyoxyethylene styryl phenyl ether salts, polyoxyethylene distyryl phenyl ether salts, polyoxyethylene tristyryl phenyl ether salts, and N-acylamino acid salts.

Preferred wetting agents are arylsulfonate salts such as Sodium Isopropyl Naphthalene Sulfonate.

Disintegrating agents are excipients that are incorporated into the granules to promote their disintegration when they come into contact with liquid or fluid matter. Suitable disintegrating agents include water-soluble polymers and polysaccharides.

Dispersing agents are substances, typically surfactants, that are added to improve the separation of the particles and to prevent their settling or clumping. Suitable dispersing agents are polycarboxylates, such as sodium polycarboxylate.

In some embodiments, granules b) consists essentially of lignin fraction.

In other embodiments, granules b) consists of lignin fraction.

Preferably, granules b) comprise the lignin fraction in a concentration of 65-95 wt %, on the weight of granules b), more preferably 70-90 wt %.

Granules b) can further comprise at least one carrier.

Preferably, in granules b), said at least one carrier is selected from lignosulphite, chalk, carboxymethylcellulose, a carbonate, hydrogen carbonate, sulphate, phosphate, oxide, or hydroxide, of potassium, sodium, lithium, calcium, magnesium, zinc, or ammonium, or urea salt or a mixture thereof.

More preferably, said at least one carrier is selected from a carbonate of potassium, or sodium, or salts of ammonia or urea and mixtures thereof.

Preferably, said granules a) and said granules b) have, independently of each other, an average particle size distribution D₅₀ of 0.5-2.0 mm.

In preferred embodiments, the average particle size distribution D₅₀ of said granules a) and the average particle size distribution D₅₀ of the said granules b) are in a ratio of 3:1 to 1:3, more preferably 2:1 to 1:2.

In particularly preferred embodiments, said granules a) and said granules b) have approximately the same average particle size distribution D₅₀.

In the most preferred embodiments, no particles having size below 0.2 mm are present in the solid mixture.

Preferably, said granules a) and said granules b) have, independently of each other, a bulk density (loose) of 0.3-0.8 g/ml, preferably 0.4-0.7 g/ml, according to ISO 3944:1992. This International Standard specifies a method for the determination of the bulk density (loose) of solid biostimulants, except powder biostimulants. The method is applicable to dry biostimulants only. If the biostimulant has absorbed moisture during transport or storage, it is necessary to dry it in an environmental chamber, with constant low humidity, prior to the determination. The method is not suitable for materials which contain a large proportion of particles exceeding 5 mm in diameter. The following standards contain provisions which, through reference in this text, constitute provisions of this International Standard:
ISO 7742:1988, Solid fertilizers—Reduction of samples.
ISO 8358:1991, Solid fertilizers—Preparation of samples for chemical and physical analysis.

For the purposes of this International Standard, the “bulk density (loose) of a fertilizer” is defined by the mass per volume of a material after it has been tipped freely into a container under specified conditions. The bulk density (loose) is expressed in grams per cubic centimetre (g/cm³).

Although these standards refer to “fertilizers”, the same have been considered by the inventors, as suitable and adoptable references also for the instant biostimulant characterization.

In preferred embodiments, said granules a) and said granules b) have approximately the same bulk density (loose).

The fact that granules a) and granules b) have similar average particle size distribution D₅₀ and/or density is important in order to minimize the risk that larger or heavier granules would be separated during transport and storage, thus leading to unbalanced administration of the biostimulant components, when re-dispersed or re-suspended in liquid formulations upon use.

Preferably, the biostimulant of the invention comprises 0.1-20 wt % of granules a) and 80-99.9 wt % of granules b), based on the weight of the solid mixture.

Particularly, in the biostimulant:
i) when said at least one carrier in granules b) is water dispersible or water soluble, the solid mixture comprises 1-15 wt % of granules a) and 85-99 wt % of granules b), and
ii) when said at least one carrier in granules b) is not water dispersible nor water soluble, the solid mixture comprises 0.1-5 wt % of granules a) and 95-99.9 wt % of granules b), based on the weight of the solid mixture.

In preferred embodiments of option i), said at least one carrier in granules b) comprises potassium carbonate, ammonia salt, urea salt, or a mixture thereof.

In preferred embodiments of option ii), said at least one carrier in granules b) comprises calcium sulphate, lignosulphite, chalk, carboxymethylcellulose, or a mixture thereof.

In further preferred embodiments, the solid mixture comprises both:
i) granules b) wherein said at least one carrier is water dispersible or water soluble, and
ii) granules b) wherein said at least one carrier is not water dispersible nor water soluble. It should be appreciated that granules b) as per option i), i.e. including at least one water dispersible or water soluble carrier, can be considered fast-release granules; in fact, the lignin fraction is easily released upon contact with water. Therefore, the biostimulant comprising granules b) as per option i) is particularly suitable for applications to a plant or plant soil, upon addition of water or as such directly to the plant soil.

Similarly, it should be appreciated that granules b) as per option ii), i.e. including at least one non-water dispersible or non-water soluble carrier, can be considered slow-release granules. Therefore, the biostimulant comprising granules b) as per option ii) is particularly suitable for applications directly to the plant soil.

Therefore, the efficacy and activity overtime of the biostimulant once applied, can be pre-set by modulating the concentration of different granules b) in the solid mixture.

Exemplary biostimulants according to the invention are reported below:
a fast-release biostimulant comprising a solid mixture of 1 wt % of granules a) comprising starch and 5×10⁹ spores/g Trichoderma and 99 wt % of granules b) (75 wt % lignin fraction+25 wt % potassium carbonate), based on the weight of the solid mixture,
a slow-release biostimulant comprising a solid mixture of 0.1 wt % of granules a) comprising starch and 5×10⁹ spores/g Trichoderma and 99.9 wt % of granules b) (85 wt % lignin fraction+15 wt % calcium sulphate), based on the weight of the solid mixture, In preferred embodiments, the biostimulant of the invention comprises a fungus of Trichoderma genus and a lignin fraction, wherein:
said fungus is selected from Trichoderma harzianum, Trichoderma atroviride Trichoderma virens, and mixtures thereof,
said lignin fraction comprises fragments having a weight average molecular weight of 3,000-20,000 Da, as measured by Size-Exclusion Chromatography.

In some preferred embodiments, the biostimulant of the invention comprises a fungus of Trichoderma genus and a lignin fraction, wherein:
said fungus is selected from Trichoderma harzianum HK2, Trichoderma atroviride HK4, Trichoderma virens GV41, and mixtures thereof,
said lignin fraction comprises fragments having a weight average molecular weight of 4,000-8,000 Da, as measured by Size-Exclusion Chromatography.

In other preferred embodiments, the biostimulant of the invention comprises a fungus of Trichoderma genus and a lignin fraction, wherein:
said fungus is selected from Trichoderma harzianum HK2, Trichoderma atroviride HK4, Trichoderma virens GV41, and mixtures thereof,
said lignin fraction comprises fragments having a weight average molecular weight of 9,000-11,000 Da, as measured by Size-Exclusion Chromatography.

The most preferred embodiments are those where the biostimulant of the invention comprises a fungus of Trichoderma genus and a lignin fraction, wherein:
said fungus is Trichoderma virens GV41,
said lignin fraction comprises fragments having a weight average molecular weight of 9,000-11,000 Da, as measured by Size-Exclusion Chromatography.

In other embodiments, the biostimulant consists essentially of a solid mixture of:
a) granules comprising a fungus of Trichoderma genus in a concentration of 1×10⁵ to 1×10¹⁰ spores/g of granules a), and at least one binding agent, and
b) granules comprising a lignin fraction in a concentration up to 90 wt %, on the weight of granules b), and optionally at least one carrier,
   wherein:
said fungus is selected from Trichoderma species, their protoplast fusants, and mixtures thereof,
said lignin fraction comprises fragments having a weight average molecular weight up to 20,000 Da, as measured by Size-Exclusion Chromatography, said fragments comprising up to 111 phenylpropane units on weight average, and
said granules a) and said granules b) have, independently of each other, an average particle size distribution D₅₀ of 0.2-4.0 mm.

For the purposes of the present invention, the expression “consists essentially of” means that said fungus and said lignin fraction are the only active ingredients acting as plant growth and fruit production promoters which are present in the biostimulant, the possible other components having different activities or being simple co-formulants.

In further embodiments, the biostimulant consists of the solid mixture, as above described.

All the combinations of the preferred aspects of the biostimulant of the invention, preparation processes, and uses disclosed above, are to be understood as herein described and similarly preferred also for the embodiments featuring the expression “consists essentially of” and the expression “consists of”.

In another aspect, the present invention relates to a process for preparing the biostimulant, said process comprising the following steps of:
1) providing granules a) obtained by mixing and granulating Trichoderma spores and at least one binding agent,
2) providing granules b) obtained by wet granulating the lignin fraction and optionally at least one carrier,
3) mixing granules a) and granules b) to obtain a solid mixture.

Preferably, an extrusion granulation is performed in step 1), where fine powders are mixed with water (10-20%) to produce a wet mixture. This mixture is passed through an extruder or pan granulator to obtain wet granules, that are then dried in an oven or fluid bed.

In particular, granules a) of vital spores of Trichoderma that are water dispersible are preferably prepared by the steps of:
milling together solid ingredients to obtain a homogeneous pre-mix
adding water to the pre-mix to obtain a wet mixture
granulating the wet mixture by any suitable technique, such as extrusion, pan granulation, agglomeration, dry spray, etc.

Preferably, the pre-mix is obtained by mixing together the following solid ingredients:

| | | |
|---|---|---|
| Trichoderma spores | 10-90 | wt. % |
| Wetting agent | 1-3 | wt. % |
| Dispersing agent | 2-15 | wt. % |
| Disintegrating agent | 0-15 | wt. % |
| Binding agent | to 100 | wt. % |

Lignin fractions typically used in the present invention are not soluble in water at neutral pH, but are soluble at basic pH.

It has been then found that water-dispersible granules b) of lignin fraction can be thus obtained by adding at least one water dispersible or water soluble carrier—which is an alkaline compound—to lignin, thus solubilizing lignin in water at basic pH. Solubilized lignin forms a colloidal dispersion in water.

Then, the solubilized lignin fraction is diluted in water at neutral pH, thus obtaining a solution/dispersion of lignin in water at pH that is physiological for plants, i.e. neutral or slightly basic pH.

Preferably the carrier is potassium carbonate.

Therefore, granules b) of lignin fractions that are water dispersible are preferably prepared by the steps of:
adding at least one water dispersible or water soluble carrier to lignin fraction, preferably potassium carbonate, the lignin fraction preferably having a dry matter content of 60-70%;
mixing up to a homogeneous paste, thus obtaining a water-dispersible lignin fraction paste;
wet granulating the water-dispersible lignin fraction paste, thus obtaining granules b).

The term dry matter content denotes solid matter content in a mixture. It is calculated as a percentage of solid material in the total mass of the mixture, % by weight.

Granulation of lignin fraction alone (i.e. without Trichoderma spores) allows taking advantage of the good thermal and chemical stability of lignin (and to avoid exposing Trichoderma to alkaline formulations in case of water-dispersible formulations), thus permitting the use of process conditions that are very advantageous in terms of costs and yield.

Non-water dispersible granules b) of lignin fraction are preferably prepared by the steps of.
providing a lignin fraction preferably having a dry matter content of 60-70%,
optionally, adding at least one non-water dispersible or non-water soluble carrier, preferably lignosulphite, chalk, carboxymethylcellulose, calcium sulphate, or a mixture thereof;
granulating the lignin fraction, optionally mixed with said carrier, in a blade rotor, inducing formation of granules by mechanical action, and
drying granules in a fluidized bed.

Due to the capacity of aggregation of lignin, the use of non-water dispersible or non-water soluble carriers is not strictly necessary. However, addition of carriers ameliorates granules texture and avoids breaking up of granules during handling, storage and use in agricultural machinery, which would otherwise produce undesired powder.

In another aspect, the present invention relates to a use of said biostimulant as a plant growth and fruit production promoter in agriculture.

Preferably, the biostimulant, in an amount of 0.1-10 wt % of biostimulant in water, can be applied in an amount of 100-300 ml per plant, every 5-15 days. Preferably, the biostimulant is in an amount of 0.5-5 wt % in water.

The granular form of biostimulant may be applied in an amount of 1-1,000 kg per hectare (ha), preferably 1-100 kg per ha, more preferably 1-10 kg per ha.

In an additional aspect, the present invention concerns an agro-chemical product comprising the biostimulant and agro-chemical additives.

Suitable additives are pH adjusters, acidity adjusters, water hardness adjusters, mineral oils, vegetal oils, fertilizers, leaf manures, and combinations thereof.

Exemplary additives include 2-ethyl hexanol EO-PO, alkoxylated alcohols, alkoxylated fatty amine, alkoxylated triglycerides, alkyl polyglycoside, alkylethersulfate sodium salt, alkylphenolethylene oxide condensate, alkylphenylhydroxypolyoxyethylene, allyl polyethylene glycol methyl ether, amphoteric dipropionate surfactant, di-l-p-menthene, dimethyl polysiloxane, esterified vegetable oil, ethylene oxide condensate, fatty acid esters, fatty alcohol ethylene oxide condensate, fatty alcohol polyalkoxylate, lecithin (soya), methylated rapeseed oil, n-dodecylpyrrolidone, n-methylpyrrolidone, n-octylpyrrolidone, non-ionic surfactant, nonyl phenol ethylene oxide condensate, paraffin oils, poly(vinylpyrrolidione/1-hexadecene, polyacrylamide, polyalkylene glycol, polyalkyleneoxide, polyether modified trisiloxane, polyethylene polypropylene glycol, polyoxyethylene monolaurate, propionic acid, styrene-butadiene co-polymer, synthetic latex, tallow amine ethoxylate, vegetable oil, and mixtures thereof.

In view of the fact that the biostimulant is effective even at very reduced concentrations of fungus and lignin fraction, the agro-chemical product advantageously and preferably comprises said biostimulant in concentration of 1-500 grams per kg of agro-chemical product.

The agro-chemical product can be in a solid or liquid form.

When the agro-chemical product is in a solid form, said solid form can be tablet, mini-tablet, micro-tablet, granule, micro-granule, pellet, multiparticulate, micronized particulate, or powder.

When the agro-chemical product is in a liquid form, said liquid form can be solution, suspension, emulsion, dispersion, drops or sprayable fluid, and can be either a water- or oily-based liquid form. Said liquid form can comprise a solvent. Suitable solvents are water, glycols, alcohols, polyalcohols, organic acids, and combinations thereof.

Preferred solvents are water, methanol, ethanol, n-propanol, iso-propanol, n-butanol, isobutanol, allyl alcohol, 1,2-propylene glycol, 1,3-propylene glycol, 1,2-ethylene glycol, polyethylene glycol (PEG), glycerol, lactic acid, polylactic acid, and mixtures thereof.

More preferred solvents are water, 1,2-propylene glycol, 1,3-propylene glycol, 1,2-ethylene glycol, polyethylene glycol (PEG), and mixtures thereof.

Preferably, when the agro-chemical product is in a liquid form, said liquid form has a pH of 5-9, more preferably 6-8.

When the agro-chemical product is in a liquid form, said liquid form comprises 1-50 wt % of the biostimulant. This means that the agro-chemical product is a concentrate that can be suitably diluted or directly mixed with other chemicals before use, if desired.

Said agro-chemical product can be bait in grains, aerosol cans, liquid (without dilution), bait in bulk, matrices, concentrated bait, fluid concentrate miscible in oils, encapsulated granules, suspension of capsules, dispersible concentrate, powder, powder for dry tanning of seeds, emulsifiable concentrate, electrically chargeable liquid, water-in-oil emulsion, emulsion for tanning of seeds, oil-in-water emulsion, smoky jar, fine granules, smoky candle, smoky cartridge, smoky slat, concentrated suspension for tanning, smoky tablet, smoking agent (fumigant), smoky granules (or pellets), gas (under pressure), granular bait, gasifiable product, microgranular, sliding powder, granular, oil-based paste, hot smoke discharging concentrate, solid/liquid combi packaging, liquid/liquid combi packaging, cold smoke discharging concentrate, solid/solid combi packaging, lacquer, solution for tanning of seeds, microemulsion, microgranular, dispersible oil, concentrated suspension miscible in oil, liquid miscible in oil, oily suspension, paste, flat bait, concentrated paste or gel, pour-on, stick for plants, treated or coated seeds, bait ready to use, spot-on, fragmented bait, concentrated suspension, suspension-emulsion, granular soluble in water, soluble concentrate, film-forming oil, powder soluble in water, soluble powder for tanning seeds, suspension, tablets, technical material, technical concentrate, powder for traces, ultralow volume liquid, hydrodispersible microgranular, hydrodispersible granular, wettable powder, wettable powder for tanning seeds, self-adhesive patch, and combinations thereof.

Advantageously, the agro-chemical product can further comprise a fertilizer comprising nitrogen, phosphorus, potassium compounds, or mixtures thereof.

In a further aspect, the present invention concerns a method for promoting plant growth and fruit production, said method comprising the step of applying the biostimulant or the agro-chemical product to a plant or plant soil.

As said above, the expression “to a plant” means that the biostimulant or the agro-chemical product can be applied to any part of the plant, including root, trunk, branch, twig, leaf, flower, and fruit. When the biostimulant is used, the same is preferably added with water before being applied to a plant.

The biostimulant or agro-chemical product can be applied by one or more of the following procedures:
mixing the biostimulant or agro-chemical product with seeds in a hopper of sowing machine,
sprinkling the biostimulant or agro-chemical product next to the sowing furrows,
sprinkling the biostimulant or agro-chemical product throughout the field before or after the last soil tillage.

When the agro-chemical product is in a liquid form, it can be applied also by one or more of the following procedures:
spraying the agro-chemical product on tubers, bulbs and seeds,
spraying the agro-chemical product on aerial part of the plant, leaves, stems,
dipping plant roots in a water solution comprising the agro-chemical product.

The agro-chemical product can be applied in an amount so as to achieve 1,000 g-10,000 kg of biostimulant per hectare (ha), preferably 1,000 g-1,000 kg per ha, more preferably 1,000 g-10,000 g per ha.

It should be also understood that all the combinations of preferred aspects of the biostimulant of the invention, as well as of the preparation processes, and uses of the same, as above reported, are to be deemed as hereby disclosed.

All combinations of the preferred aspects of the biostimulant of the invention, preparation processes, and uses disclosed above are to be understood as herein described.

Below are working examples of the present invention provided for illustrative purposes.

### EXAMPLES

M_{w} and Mₙ in these Examples were measured by Size-Exclusion Chromatography according to the following procedure.

“wt %” means weight percentage based on the weight of the organic-inorganic hybrid material, unless otherwise specified.

### Reagents and Materials

Eluent: 0.1 M NaOH, flow 0.5 ml/min
Calibration for RI detector: Pullulan standards, Mₚ: 100,000—1,080 (six standards), where Mₚ is peak maximum molecular weight
Calibration for UV-detector (280 nm): PSS standards, polystyrenesulfonate sodium salt, Mₚ 65,400—891 (six standards). Standards are dissolved into ultra-pure water, concentration should be approximately 5 mg/ml. Injection volume is 20 μl.
Quality control samples: lignin with known M_{w} distribution is used.

### Equipment and Instruments

Dionex Ultimate 3000 Autosampler, column compartment, and pump
Dionex Ultimate 3000 Diode Array Detector
Reflective Index detector: Shodex RI-101
Columns: PSS MCX columns: precolumn and two analytical columns: 1000 Å and 100 000 Å, column material is sulfonated divinylbenzen copolymer matrix.
Syringe filters 0.45 μm and glass sample bottles for STD samples. Sample filtration: Mini-Uniprep syringeless filter device PTFE or Nylon, 0.45 μm. For prefiltration 5 μm syringe filter if needed.
Measuring bottles

### Procedure

### Preparation of the Eluent

Ideally, water used to prepare eluents should be high quality deionized water of low resistivity (18 MΩ·cm or better) that contains as little dissolved carbon dioxide as possible. The water must be free of biological contamination (e.g., bacteria and molds) and particulate matter.

Needle Washing with 10% MeOH-Water

### Liquid Samples

Strong alkaline liquor samples are diluted 1:100 and filtered with PTFE syringe filters (0.45 μm) to vials. Solid lignin samples are diluted and dissolved into 0.1 M NaOH and filtered with PTFE, 0.45 μm syringe filters. Ready samples are load into autosampler. Injection volume is 20 μl. After samples 1 M NaOH is injected as a sample to clean the column.

### Instrument Parameters:

Flow rate 0.5 ml/min
Eluent 0.1 M NaOH
Column oven temperature 30° C.
Isocratic run
Run time 48 minutes

### Solid Samples

Solid samples (lignin) are dried overnight in an oven at 60° C., if needed. Approximately 10 mg is weighed into a 10-ml measuring bottle. Sample is dissolved and diluted into 0.1 M NaOH solution and filled into a mark. Sample is filtered with PTFE, 0.45 μm filters. If sample does not dissolve properly, it can be put in a ultrasound water bath or sample can be filtered through a 5 μm syringe filter.

### Standard Samples for Calibration

Approximately 50 mg of each standard is weighed into a 10-ml measuring bottle and ultrapure water is added and filled into a mark. Standards are filtered with PTFE 0.45 μm syringe filters. After running the calibration samples, calibration results are integrated and processed in the processing method and saved. Calibration is linear 1st order calibration.

### Quality Control Samples

For lignin samples, lignin with known M_{w} distribution is used as a quality control sample. Lignin is dissolved into 0.1 M NaOH and the concentration is approximately 1 mg/ml.

### Example 1

Beech wood (Fagus sylvatica) was subjected to an alkaline and enzymatic hydrolysis whereby lignin fraction free from hemicellulose and cellulose was obtained. Lignin fraction thus separated has the following characteristics:

>95% of total solids
M_{w} 9,000-11,000 Da (50-61 phenylpropane units)
essentially sulphur-free (sulphur content less than 3%)
comprises 23-29 wt % of cellulose.

### Example 2

The following lignin fraction was extracted from Kraft black liquor, said lignin fraction having the following characteristics:

>95% of total solids
Single Species: Southern Pine
M_{w} 4400-5000 Da (24-28 phenylpropane units)
Mₙ 1200-1300 Da (6-7 phenylpropane units)

### Structures of OH-Groups:

| | | |
|---|---|---|
| aliphatic | 2.1 | mmol/g |
| carboxylic | 0.5 | mmol/g |
| condensated and syringyl | 1.7 | mmol/g |
| guaiacyl | 2.0 | mmol/g |
| catecholic and p-OH-phenyl | 4.0 | mmol/g |

### Example 3

### Preparation of Granules a) of Trichoderma Fungus

A pre-mix was prepared by milling together the following ingredients:

| Ingredient | Supplier | Amount (wt. %) |
|---|---|---|
| Trichoderma spores (GV41) | Green Innovation GmbH | 20 |
| Wetting agent (Supragil ®, Sodium | Solvay | 2 |
| Isopropyl Naphthalene Sulfonate) | | |
| Dispersing agent (Geropon ® | Solvay | 3 |
| TA/72, sodium polycarboxylate) | | |
| Binding agent (ARGIREC ™ B22, | Lehvoss | 75 |
| kaoline) | | |

The pre-mix was granulated by extrusion granulation:
first, the fine powders pre-mix has been mixed with water (15 wt %) to produce a moistured mixture. Then, the moistured mixture was passed through an extruder (i.e. a basket) to obtain wet granules, having the shape of cylindrical micro-pellets. The granules were then dried in a fluidized bed dryer.

Water-dispersible granules comprising 1-2 10¹⁰ vital spores for gram of granule were obtained, having a particle size distribution D₅₀ of 1.5 mm, sieved in a fraction between 1400 microns and 500 microns, as measured by sieve analysis in accordance with EN 1235.

### Example 4

### i) Preparation of Water Dispersible Granules b) of Kraft Lignin Fraction

Water dispersible granules b) of lignin fraction of Example 2 were prepared as follows:
1) dry mixing powders of lignin fraction (having a dry matter content of 70%) and potassium carbonate, in a weight ratio of 70:30,
2) mixing, up to complete extinction of exothermic reaction, and
3) granulating the resulting mixture in a blade rotor, inducing formation of granules by mechanical action,
4) drying granules in a fluidized bed, having an average particle size distribution D₅₀ of 1 mm, sieved in a fraction between 1400 microns and 250 microns as measured by sieve analysis in accordance with EN 1235.

### ii) Preparation of Non-Water Dispersible Granules b) of Lignin Fraction

Non-water dispersible granules b) of lignin fraction were prepared as follows:
1) providing a lignin fraction having a dry matter content of 65%,
2) adding 3 wt % of lignosulphite,
3) granulating the mixture in a blade rotor, inducing formation of granules by mechanical action,
4) drying granules in a fluidized bed, the granules having an average particle size distribution D₅₀ of 2 mm, sieved in a fraction between 2000 microns and 250 microns as measured by sieve analysis in accordance with EN 1235.

### Example 5

### a) Preparation of a Biostimulant Comprising the Granules a) of Ex. 3 and Granules b) of Ex. 4.i

A granular product was prepared by mixing:
30 g of granules a) of Example 3 and 970 g of water dispersible granules b) of Example 4.i comprising lignin fraction and potassium carbonate.

### b) Preparation of a Biostimulant Comprising the Granules a) of Ex. 3 and Granules b) of Ex. 4.ii

A granular product was prepared by mixing, containing lignin fraction and a concentration of 3×10⁶ viable spores/gram of Trichoderma.

In particular, the product comprises:
4 g of granules a) of Example 3 and 996 g of non-water dispersible granules b) of Example 4.ii.

### Example 6

### Evaluation of the Biostimulant Activity of the Biostimulant Prepared in Ex. 5 on Endive Escarole

Biostimulant activity of the biostimulant product prepared in Ex. 5a was assessed on endive scarole plants.

The transplanting was carried out on September 10, by using seedlings raised in cellular boxes with 104 cells filled with growth soil medium.

The experimental design was a randomized block with 3 replicates as follows:

| | |
|---|---|
| Treatments | 3 |
| Replicates | 3 |
| Basic parcel | 39 plants spaced by 30 cm in |
| | the row and 40 cm between rows |

| | | Concentration | Biostimulant | |
|---|---|---|---|---|
| | | (Trichoderma | dosage | |
| Treatments | Product | spores) | in kg/ha | |
| 1 (control) | Non-treated | — | — | |
| 2 | Agro-chemical | ≥10⁷ CFU/g | 10 Kg/ha − 1 | to be located |
| | product of the | | g/m² | in the |
| | invention | | 5 Kg/ha | transplant |
| | | | | hole |
| | | | | after 9 days |
| | | | | by manual |
| | | | | irrigation |
| 3 | Comparative | 10⁷ CFU/g | 4 Kg/ha − 0.4 g/ | Immerse the |
| | product | | m² (for dilution | blister |
| | (Liquid product | | in 0.1 lt water) | cassette in the |
| | comprising: | | | suitably |
| | mycorrhizae | | | diluted |
| | (Glomus spp.) | | | product; |
| | 0.2% | | | repeat the |
| | rhizosphere | | | treatment |
| | bacteria 1.2 × 10⁵ | | | after 9 days |
| | U.F.C./g | | | by manual |
| | Trichoderma | | | irrigation. |
| | spp. 6 × 10⁷ | | | |
| | U.F.C./g) | | | |

The application of the agro-chemical product of the invention was carried out in pre-transplantation by locating it near the row where the seedlings would have been transplanted, then after 9 days it was administered by manual irrigation.

The treatment with the comparative product was carried out by immersing the alveolar box with the seedlings in an aqueous solution and by manual irrigation 9 days after the transplant.

During the vegetative phase, the possible phytotoxicity of the biostimulant products administered was detected (found to be absent) and, at commercial “maturity”, the vegetative vigor was determined, assigning a score from 0 to 100.

The harvest was done manually about on October 28 (i.e. seven weeks from transplanting). A total of 20 plants per parcel were collected. In order to favor bleaching, of the remaining plants were tied with elastic for each parcel. The tied plants were collected on November 11 (i.e. two weeks from tying).

The harvested plants were weighed as they are (raw weight) and after husking.

The data obtained were statistically analyzed by variance analysis using the MSTATC program.

The analysis of variance showed statistically significant differences only for the “Force” character for which the treated theses passed the check (Table 1).

The agro-product of the invention demonstrated to be superior for all the features considered.

TABLE 1
plants' vigor; production (t/ha), raw (before husking) and neat (after husking),
for plant as it is and tied. Values with at least one letter in common are not
significantly different according to the Duncan test with a probability of 95%

| | | Before tying | | | After tying | | |
|---|---|---|---|---|---|---|---|
| | | Raw product | Neat | Neat | Raw product | Neat | Neat |
| Treatment | Vigor | t/ha | t/ha | % | t/ha | t/ha | % |
| control | 60 B | 22.85 | 17.22 | 75% | 45.02 | 28.90 | 64% |
| Invention prod | 80 A | 29.28 | 22.85 | 78% | 45.65 | 30.35 | 66% |
| Comparative prod | 83.3 A | 28.49 | 20.58 | 72% | 40.47 | 25.28 | 62% |

Considering the production (t/ha) of tufts before and after husking, it can be seen that treatment with the product of the invention showed the highest production, both as raw and as neat, with respectively 29.28 and 22.855 t/ha, followed by the comparative commercial biostimulant (28.4 and 20.58 t/ha) and control (22.84 and 17.22 t/ha).

### Example 7

### Evaluation of the Biostimulant Activity of the Biostimulant Prepared in Ex. 5a on Tomatoes

The test was carried out on mulched soil using the industrial tomato variety PIETRAROSSA.

The transplanting was carried out on June 18 using seedlings raised in alveolar boxes with 104 cells filled with growth soil medium. The experimental design was a randomized block with 3 replicates as follows:

| | |
|---|---|
| Treatments | 3 |
| Replicates | 3 |
| Basic parcel | 20 plants spaced by 25 cm in the |
| | row and 150 cm between rows |

| | | Concentration | Biostimulant | |
|---|---|---|---|---|
| | | (Trichoderma | dosage | |
| Treatments | Product | spores) | in kg/ha | |
| 1 (control) | Non-treated | — | — | |
| 2 | Agro-chemical | ≥10⁷ CFU/g | 10 Kg/ha − 1 | to be located |
| | product of the | | g/m² | in the |
| | invention | | 5 Kg/ha | transplant |
| | | | | hole |
| | | | | 2 treatments |
| | | | | after 9-13 |
| | | | | days by |
| | | | | manual |
| | | | | irrigation |
| 3 | Comparative | 10⁷ CFU/g | 4 Kg/ha − 0.4 g/ | Immerse the |
| | product | | m² (for dilution | blister |
| | (Liquid product | | in 0.1 lt water) | cassette in the |
| | comprising: | | | suitably |
| | mycorrhizae | | | diluted |
| | (Glomus spp.) | | | product; |
| | 0.2% | | | repeat the |
| | rhizosphere | | | treatment |
| | bacteria 1.2 × 10⁵ | | | after 9 days |
| | U.F.C./g | | | by manual |
| | Trichoderma | | | irrigation. |
| | spp. 6 × 10⁷ | | | |
| | U.F.C./g) | | | |

The application of the agro-chemical product of the invention was carried out in pre-transplantation by locating it in the mulch hole; subsequently after 9 and 13 days it was administered by manual irrigation.

The commercial product was administered by immersing the alveolar cassette with the seedlings in a solution with the product and by manual irrigation 9 days after the transplant.

The development of the crop was delayed due to the late transplant period and the use of aged seedlings. In the first 15 days the transplanted seedlings showed little development.

Growth was then regular.

During the vegetative phase, any phytotoxicity of the biostimulant products administered was verified and it was absent. When all the plants in the parcel showed at least 5-10 flowers, the date of beginning of flowering was detected, which on average occurred 33 days after transplanting. At complete veraison, the vegetative vigor was detected by assigning a score from 0 to 100.

The harvest was carried out manually on September 20 (i.e. 13 weeks from transplanting), dividing the berries into commercial (red), immature (green) and waste; the first two categories were weighed, while for the third only the number of berries was detected. The average berry weight was calculated on a sample of 30 commercial berries. For the determination of the ° Brix, 3 berries per parcel were used.

The data obtained were statistically analyzed by variance analysis using the MSTATC program.

The analysis of variance showed statistically significant differences only for the vigor of the plants (Table 2) which justifies the total and commercial production clearly superior to the control obtained with the product of the invention (Table 3).

TABLE 2
Optical residue (° Brix), vigor of the plants (score from 0 to 100),
average weight of the commercial berry (g) and height of the plant at the
end of veraison (cm). Values with at least one letter in common are not
significantly different according to Duncan's test with a probability of 95%.

| | | | Berry's | Plant's height |
|---|---|---|---|---|
| Treatments | Brix | Vigor (0-100) | weight (g) | (cm) |
| Control | 4.23 | 70 B | 68.07 | 58.43 |
| Agro-product of the | 4.40 | 90 A | 75.87 | 59.77 |
| invention | | | | |
| Comparative prod. | 3.97 | 93.3 A | 76.20 | 59.13 |
| Coefficient of variation | 7.40% | 3.95% | 4.27% | 7.87% |

TABLE 3
Total production (t/ha) subdivided into commercial, unripe and waste (n
° berries/plant). Values with at least one letter in common are not
significantly different according to Duncan's test with a probability of 95%.

| | Total Product | Commercial product | Unripe | waste |
|---|---|---|---|---|
| Treatments | (t/ha) | (t/ha) | (t/ha) | (n° berries/plant) |
| Control | 42.61 | 39.77 | 2.84 | 4.20 |
| Agro-product of | 60.05 | 55.54 | 4.51 | 5.63 |
| the invention | | | | |
| Comparative | 49.10 | 47.78 | 1.32 | 5.57 |
| prod. | | | | |
| Coefficient of | 15.10% | 15.08% | 41.68% | 15.42% |
| variation | | | | |

The vigor of the plant assigned at the end of veraison through a score from 0 to 100 is shown in Table 2. The most vigorous plants were found in the thesis with comparative commercial product (93.3%) and the product of the invention (90%) while the control was significantly lower (70%).

Table 2 also shows the sugar content of the berry—° Brix, the height of the plant at the end of veraison and the average weight of the commercial berry which are comparable in each treatment.

### Example 8

### Evaluation of the Biostimulant Activity of the Biostimulant Prepared in Ex. 5b on Birch Plants

50 g or 500 g of the biostimulant product were mixed with 1 m³ of growth media (peat based)

The growth media was distributed into plant pots and birch seeds were sown to each pot
(Growth period March-June-three and half months)
81 plant seedling tray was taken for analysis
Stem length and thickness (FIG. 1A) and nutrient uptake (FIG. 1B) from the leaves were
analyzed, and the results summarized in table 4 below.

TABLE 4

Applied amount g/m³

| | Method | Unit | 0 | 50 | 500 |
|---|---|---|---|---|---|
| Stem length | | cm | 28.4 | 35.8 | 39.6 |
| Number of leaves > 1 cm | | | 6.9 | 8.0 | 8.2 |
| Stem thickness | | mm | 2.76 | 2.90 | 3.00 |

The results clearly show that the agrochemical product of the invention enhanced the growth of birch seedlings, increased stem thickness and number of leaves.

1. A biostimulant for promoting plant growth and fruit production, the biostimulant comprising a solid mixture of:
a) granules comprising a fungus of Trichoderma genus in a concentration of 1×10⁵ to 1×10¹⁰ spores/g of granules a), and at least one binding agent, and
b) granules comprising a lignin fraction in a concentration at least 50 wt %, on the weight of granules b),
wherein:
said fungus is selected from Trichoderma species, their protoplast fusants, and mixtures thereof,
said lignin fraction comprises fragments having a weight average molecular weight up to 20,000 Da, as measured by Size-Exclusion Chromatography, said fragments comprising up to 111 phenylpropane units on weight average, and
said granules a) and said granules b) have, independently of each other, an average particle size distribution D₅₀ of 0.2-4.0 mm, measured by sieve analysis in accordance with EN 1235.

2. The biostimulant of claim 1, wherein said Trichoderma species is selected from Trichoderma aggressivum, Trichoderma asperellum, Trichoderma atroviride, Trichoderma citrinoviride, Trichoderma cremeum, Trichoderma harzianum, Trichoderma koningii, Trichoderma longibrachiatum, Trichoderma reesei, Trichoderma virens, Trichoderma viride, Trichoderma viridescens, and mixtures thereof.

3. The biostimulant of claim 1, wherein said fungus is selected from T. Harzianum, T. Atroviride and T. virens, and mixtures thereof.

4. The biostimulant of claim 3, wherein said fungus is selected from T. Harzianum HK2, T. Atroviride HK4 and T. virens GV41, and mixtures thereof.

5. The biostimulant of claim 1, wherein said fungus is in a concentration of 1×10⁵ to 1×10¹⁰ spores/g of granules a).

6. The biostimulant of claim 1, wherein said lignin fraction in a concentration of 65-95 wt %, preferably 70-90 wt %, on the weight of granules b).

7. The biostimulant of claim 1, wherein said lignin fraction comprises fragments having a weight average molecular weight of 2,000-20,000 Da, preferably 3,000-20,000 Da, more preferably 4,000-15,000 Da.

8. The biostimulant of claim 1, wherein said lignin fraction comprises fragments having a weight average molecular weight of 4,000-8,000 Da.

9. The biostimulant of claim 1, wherein, in granules a), said at least one binding agent is selected from kaoline, starch, modified starch, starch phosphate, pectin, modified pectin, amylopectin, alginic acid, sodium alginate, guar gum, guar flour, tragacanth, gum arabic, xanthan gum, karaya gum, tara gum, tamarind gum, gellan gum, locust bean gum, gelatin, carob seed flour, galactomannan, glucomannan, dextran, carrageenan, mannan, arabinogalactan, pullulan, maltodextrin, cellulose, derivatized cellulose, carboxymethyl cellulose, sodium carboxymethyl cellulose, soy polysaccharide, chitosan, or a mixture thereof.

10. The biostimulant of claim 1, wherein granules b) further comprise at least one carrier, said at least one carrier being selected from chalk, carboxymethylcellulose, a carbonate, hydrogen carbonate, sulphate, phosphate, oxide, or hydroxide, of potassium, sodium, lithium, calcium, magnesium, zinc, or ammonium, or a mixture thereof.

11. The biostimulant of claim 1, wherein said granules a) and said granules b) have, independently of each other, an average particle size distribution D₅₀ of 0.5-2.0 mm.

12. The biostimulant of claim 1, comprising 0.1-20 wt % of granules a) and 80-99.9 wt % of granules b), based on the weight of the solid mixture.

13. The biostimulant of claim 12, wherein:
i) when said at least one carrier in granules b) is water dispersible or water soluble, the solid mixture comprises 1-15 wt % of granules a) and 85-99 wt % of granules b), and
ii) when said at least one carrier in granules b) is not water dispersible nor water soluble, the solid mixture comprises 0.1-5 wt % of granules a) and 95-99.9 wt % of granules b),
based on the weight of the solid mixture.

14. The biostimulant of claim 13, wherein said at least one carrier in granules b) is water dispersible or water soluble and comprises potassium carbonate.

15. The biostimulant of claim 13, wherein said at least one carrier in granules b) is not water dispersible nor water soluble and comprises lignosulphite, chalk, carboxymethylcellulose (CMC), calcium sulphate, or a mixture thereof.

16. The biostimulant of claim 1,
wherein the solid mixture comprises both:
i) granules b) wherein said at least one carrier is water dispersible or water soluble, and
ii) granules b) wherein said at least one carrier is not water dispersible nor water soluble.

17. (canceled)

18. An agro-chemical product comprising the biostimulant of claim 1 and agro-chemical additives.

19. Method for promoting plant growth and fruit production, said method comprising the step of applying the biostimulant of claim 1 to a plant or plant soil.
